(19) United States
(12) Patent Application Publication
(10) Pub. No.: US 2009/0221784 A1
(43) Pub. Date: Sep. 3, 2009

(54) BIODEGRADABLE POLYURETHANES

(76) Inventors: Scott A. Guelcher, Franklin, TN (US); Jonathan E. Didier, Pittsburgh, PA (US); Jeffrey O. Hollinger, Gibsonia, PA (US)

Correspondence Address: BARTONY & HARE, LLP, 1806 FRICK BUILDING, 437 GRANT STREET, PITTSBURGH, PA, 15219-6101, US

(21) Appl. No.: 12/298,158

(22) PCT Filed: Apr. 24, 2006
(86) PCT No.: PCT/US06/15485

§ 371 Date: Oct. 23, 2008

(51) Int. Cl. C08G 18/18; C08G 18/10; C08G 18/16

(52) U.S. Cl. 528/49; 528/59; 528/48

(57) ABSTRACT

A method for preparing biodegradable polyurethanes includes contacting a flowable quasi-pre-polymer including free aliphatic polyisocyanate compounds with a polyester polyol hardener having a functionality of at least two to form a reactive liquid mixture. The quasi-prepolymer can, for example, be formed by contacting a polyisocyanate component comprising at least one aliphatic polyisocyanate compound with a polyol component comprising at least one polyol compound to form an adduct of the polyisocyanate component and the polyol component wherein a sufficient excess of the polyisocyanate component is used to form the quasi-prepolymer.

### BACKGROUND OF THE INVENTION

The present invention relates generally to biodegradable polyurethanes and, particularly, to biodegradable polyurethanes formed using quasi-prepolymers.

Bone grafts are often required to promote the healing of segmental bone defects. Although autograft bone represents the best standard of care, it is limited in supply and must be harvested by an invasive surgical procedure. In an alternative tissue engineering approach, scaffolds have been fabricated from synthetic polymers to promote healing by creating natural living tissue.

Increasing demand for healing therapeutics administered by minimally invasive surgical techniques requires the synthesis of new injectable biomaterials. Orthopaedic clinical indications for injectable biomaterials include distal radius and vertebral compression fractures, as well as treatments to enhance fracture healing. See, for example, Praemer, A.; Furner, S.; Rice, D., Musculoskeletal conditions in the United States. In American Academy of Orthopaedic Surgeons, Park Ridge, Ill., 1992; Vol. AAOS, pp 85-124, the disclosure of which is incorporated herein by reference. Ideally, scaffolds should support the attachment and proliferation of cells and ingrowth of new tissue, biodegrade at a rate in register with tissue healing, possess mechanical properties similar to those of bone, and deliver bioactive components which promote tissue healing. Temenoff, J. S.; Mikos, A. G., Injectable biodegradable materials for orthopedic tissue engineering. Biomaterials 2000, 21, 2405-2412 and Kempen, D. H. R.; Lu, L.; Kim, C.; Zhu, X.; Dhert, W. J. A.; Currier, B. L.; Yaszemski, M. J., Controlled drug release from a novel injectable biodegradable microsphere/scaffold composite based on poly(propylene fumarate). J Biomed Mater Res 2006, 77A, 103-111, the disclosures of which are incorporated herein by reference.

Biodegradable two-component poly(ester urethane) networks have been synthesized from lysine diisocyanate (LDI) and hydroxyl-terminated copolymers of ε-caprolactone, glycolide, and DL-lactide by both one-shot and prepolymer processes. See, for example, Bruin, P.; Veenstra, G. J.; Nijenhuis, A. J.; Pennings, A. J., Design and synthesis of biodegradable poly(ester-urethane) elastomer networks composed of non-toxic building blocks. Makromol Chem, Rapid Commun 1988, 9, 589-594, Storey, R. F.; Wiggins, J. S.; Mauritz, K. A.; Puckett, A. D., Bioadsorbable composites II: Nontoxic, L-lysine-based poly(ester-urethane) matrix composites. Polymer Composites 1993, 14, 17-25, Storey, R. F.; Wiggins, J. S.; Puckett, A. D., Hydrolyzable poly(ester-urethane) networks from L-lysine diisocyanate and D,L-lactide/ε-caprolactone homo- and copolyester triols. Journal of Polymer Science, Part A: Polymer Chemistry 1994, 32, (12), 2345-2363, Wiggins, J. S.; Storey, R. F., Synthesis and characterization of L-lysine-based poly(ester urethane) networks. Polymer Preprints 1992, 33, (2), 516-517, Published PCT International Patent Application No. WO 2004/009227 A2, and Gunatillake, P. A.; Adhikari, R.; Le, T. P.; Danon, S. J.; Seymour, K.; McFarland, C.; Bean, P.; Mitchell, S.; Dalton, A.; Werkmeister, J.; Ramshaw, J. A.; White, J.; Glattauer, V.; Tebb, T. In Injectable biodegradable polyurethanes for tissue engineering, 7th World Biomaterials Congress, Sydney, Australia, 2004; Sydney, Australia, 2004; p 109A, the disclosures of which are incorporated herein by reference. Such polymers have been reported to degrade to non-toxic by-products and to support the migration of cells and growth of new tissue both in vitro and in vivo. See Published PCT International Patent Application No. WO 2004/009227 A2, Gunatillake, P. A.; Adhikari, R.; Le, T. P.; Danon, S. J.; Seymour, K.; McFarland, C.; Bean, P.; Mitchell, S.; Dalton, A.; Werkmeister, J.; Ramshaw, J. A.; White, J.; Glattauer, V.; Tebb, T. In Injectable biodegradable polyurethanes for tissue engineering, 7th World Biomaterials Congress, Sydney, Australia, 2004; Sydney, Australia, 2004, Zhang, J.-Y.; Beckman, E. J.; Hu, J.; Yuang, G.-G.; Agarwal, S.; Hollinger, J. O., Synthesis, biodegradability, and biocompatibility of lysine diisocyanate-glucose polymers. Tissue Eng 2002, 8, (5), 771-785, Zhang, J.-Y.; Beckman, E. J.; Piesco, N. J.; Agarwal, S., A new peptide-based urethane polymer: synthesis, biodegradation, and potential to support cell growth in vitro. Biomaterials 2000, 21, 1247-1258, Zhang, J.; Doll, B.; Beckman, E.; Hollinger, J. O., A biodegradable polyurethane-ascorbic acid scaffold for bone tissue engineering. J Biomed Mater Res 2003, 67A, (2), 389-400, Zhang, J.; Doll, B.; Beckman, J.; Hollinger, J. O., Three-dimensional biocompatible ascorbic acid-containing scaffold for bone tissue engineering. Tissue Eng 2003, 9, (6), 1143-1157, Bruin, P.; Veenstra, G. J.; Nijenhuis, A. J.; Pennings, A. J., Design and synthesis of biodegradable poly(ester-urethane) elastomer networks composed of non-toxic building blocks. Makromol Chem, Rapid Commun 1988, 9, 589-594, and Bennett, S.; Connolly, K.; Lee, D. R.; Jiang, Y.; Buck, D.; Hollinger, J. O.; Gruskin, E. A., Initial biocompatibility studies of a novel degradable polymeric bone substitute that hardens in situ. Bone 1996, 19, (1, Supplement), 101S-107S, the disclosures of which are incorporated herein by reference.

In the one-shot process, the polyisocyanate is mixed with the polyol component to form a reactive liquid mixture which is then cast and cured to form a solid material. However, because of incompatibility between the polyisocyanate and polyester polyol phases, the reactive liquid mixture can phase-separate, resulting in incomplete cure and poor mechanical properties. See Mueller, H. P.; Franke, J.; Sanders, J., New developments in isocyanate-based casting resins for the electrical and electronics industry. Advances in Urethane Science and Technology 1993, 12, 166-207, the disclosure of which is incorporated herein by reference.

In the two-step prepolymer process, miscibility of the two phases is promoted by first preparing an NCO-terminated prepolymer which is then further reacted with a polyol and cured to form a solid. However, the viscosity of NCO-terminated polyester prepolymers is typically high, thereby rendering these materials difficult to process. For example, NCO-terminated prepolymer used to synthesize the cast poly(ester urethane) (prepared from prepared from LDI and poly(ε-caprolactone) having a molecular weight 300 Da) of Published PCT International Patent Application No. WO 2004/009227 had a viscosity of 87,000 cSt. The polymer formed via the prepolymer process of had a Young's modulus of 837 MPa and a compressive strength of 61.9 MPa.

As an alternative to one-shot and prepolymer processes, quasi-prepolymers have been prepared for use in synthesis of industrial, non-biodegradable and non-biocompatible polyurethanes. See Cardy, C. F. Process for preparing poly(ε-caprolactone) polyurethanes. U.S. Pat. No. 4,086,214, Apr. 25, 1978, 1978, Oertel, G., Polyurethane Handbook. 2nd ed.; Hanser Gardner Publications: Berlin, 1994, and Szycher, M., Szycher's Handbook of Polyurethanes. CRC Press: Boca Raton, 1999, the disclosure of which are incorporate herein by reference. The use of quasi-prepolymers in synthesis of industrial polyurethanes has been found to improve miscibility and processing. In the quasi-prepolymer process, a polyol is contacted with a large excess of polyisocyanate. The resulting intermediate comprises an adduct of polyisocyanate and polyol solubilized/dissolved in an excess of polyisocyanate.

It remains desirable to develop improved biodegradable polyurethanes and methods of synthesis and processing thereof.

### SUMMARY OF THE INVENTION

In one aspect, the present invention provides a method for preparing biodegradable polyurethanes including contacting a flowable quasi-prepolymer including free aliphatic polyisocyanate compounds with a polyester polyol hardener having a functionality of at least two to form a reactive liquid mixture. The quasi-prepolymer can, for example, be formed by contacting a polyisocyanate component including at least one aliphatic polyisocyanate compound with a polyol component comprising at least one polyol compound to form an adduct of the polyisocyanate component and the polyol component wherein a sufficient excess of the polyisocyanate component is used to form the quasi-prepolymer.

The polyisocyanate component can, for example, be contacted with the polyol component in the presence of a catalyst. The catalyst can, for example, be a tertiary amine or an organobismuth compound.

The quasi-prepolymer can be formed by contacting a polyisocyanate component including at least one aliphatic polyisocyanate compound with a polyol component including at least one polyol compound, wherein the molar ratio of aliphatic polyisocyanate compounds to polyol compounds is at least 2:1 and subsequently adding aliphatic polyisocyanate compound.

The quasi-prepolymer can also be formed by contacting a polyisocyanate component including at least one aliphatic polyisocyanate compound with a polyol component including at least one polyol compound, wherein the molar ratio of aliphatic polyisocyanate compounds to polyol compounds is greater than 2:1. In another embodiment, the molar ratio of aliphatic polyisocyanate compounds to polyol compounds is greater than 3:1. In still another embodiment, the molar ratio of aliphatic polyisocyanate compounds to polyol compounds is greater than 4:1.

The flowable quasi-prepolymer can include free aliphatic polyisocyanate compounds of at least 1% by weight. The flowable quasi-prepolymer can also include free aliphatic polyisocyanate compounds of at least 10% by weight. The flowable quasi-prepolymer can also include free aliphatic polyisocyanate compounds of at least 20% by weight. The flowable quasi-prepolymer can also include free aliphatic polyisocyanate compounds of at least 30% by weight.

The polyester polyols used in the present invention preferably have a functionality greater than 2.0. The polyester polyol can, for example, have a functionality of at least 2.5. The functionality can be an average functionality if a mixture of polyester polyols is used. Preferably, the polyester polyols are hydroxyl-terminated compounds having hydrolysable ester linkages: The polyester polyol can, for example, include a polyalkylene glycol ester or a polyester prepared from at least one cyclic ester. The polyester polyol can, for example, include at least one of poly(ethylene adipate), poly(ethylene glutarate), poly(ethylene azelate), poly(trimethylene glutarate), poly(pentamethylene glutarate), poly(diethylene glutarate), poly(diethylene adipate), poly(triethylene adipate), poly(1,2-propylene adipate), a mixture thereof, or a copolymer of at least two thereof. In several embodiment, the polyester polyol comprises polyesters prepared from at least one of ε-caprolactone, glycolide or DL-lactide. The polyester polyol can also include polyesters prepared from castor-oil. The above polyester polyols can be used as the polyester polyol hardener used in forming the reactive liquid mixture and/or within the polyol component used in forming the quasi-prepolymer.

The polyisocyanate component preferably has an average isocyanate functionality of at least 2. The polyisocyanate component can also have an average isocyanate functionality of at least 2.5. The polyisocyanate compounds can, for example, include at least one of lysine diisocyanate, an alkyl ester of lysine diisocyanate, lysine triisocyanate, hexamethylene diisocyanate, isophorone diisocyanate (IPDI), 4,4′-dicyclohexylmethane diisocyanate, cyclohexyl diisocyanate (H₁₂MDI), 2,2,4-(2,2,4)-trimethylhexamethylene diisocyanate (TMDI), dimers prepared form aliphatic polyisocyanates or trimers prepared from aliphatic polyisocyanates. The polyisocyanate compounds can, for example, include at least one of hexamethylene diisocyanate dimer, hexamethylene diisocyanate trimer, isophorone diisocyanate dimer, or isophorone diisocyanate trimer. The alkyl ester of lysine diisocyanate can, for example, be lysine diisocyanate methyl ester or lysine diisocyanate ethyl ester. In several embodiment, the polyisocyanate compounds include lysine triisocyanate.

A catalyst can be added to the polyester polyol before contacting the quasi-prepolymer with the polyester polyol. The catalyst can, for example, be a tertiary amine or an organobismuth compound.

A crosslinker can, for example, be added to the polyester polyol before contacting the quasi-prepolymer with the polyester polyol. The crosslinker preferably has a functionality of at least 3 and a molecular weight of no more than 300 g/mol. The crosslinker can, for example, include at least one of glycerol, pentaerythritol, dipentaerythritol, tripentaerythritol, 1,2,4-butanetriol, trimethylolpropane, 1,2,3-trihydroxyhexane, myo-inositol, ascorbic acid, a saccharide, or a sugar alcohol.

The method can further include the step of casting the reactive liquid mixture into a mold. The method can also include the step of curing the biodegradable polyurethane in the mold. The entire casting process of the present invention can proceed as described above without that addition of or the use of solvents.

The polyol component can, for example, include at least one polyester polyol as described above and/or one or more starter compounds that preferably have a functionality of at least 3 and a molecular weight of no more than 300 g/mol. The starter can, for example, include at least one of glycerol, pentaerythritol, dipentaerythritol, tripentaerythritol, 1,2,4-butanetriol, trimethylolpropane, 1,2,3-trihydroxyhexane, myo-inositol, ascorbic acid, a saccharide, or a sugar alcohol.

In another aspect, the present invention provides a quasi-prepolymer formed by contacting a polyisocyanate component including at least one aliphatic polyisocyanate compound with a polyol component including at least one polyol compound wherein an excess of the polyisocyanate component is used to result in free isocyanate component.

In another aspect, the present invention provides a quasi-prepolymer formed by contacting a polyisocyanate component including at least one aliphatic polyisocyanate compound with a polyol component including at least one polyol compound and subsequently adding polyisocyanate compounds to result in free isocyanate component.

In a further aspect, the present invention provides a biodegradable polyurethane formed by contacting a flowable quasi-prepolymer including free aliphatic polyisocyanate compounds with a polyester polyol hardener having a functionality of at least two to form a reactive liquid mixture. The biodegradable polyurethanes can be hard polyurethanes, having a modulus greater than 300 MPa, suitable, for example, for use in bone tissue engineering. The biodegradable polyurethanes can also have a modulus greater than 837 MPa, or even greater than 1000 MPa. The biodegradable polyurethanes can also have a compressive strength greater than 61.9 MPa, greater than 70 MPa, or even greater than 80 MPa.

In another aspect, the present invention provides a biodegradable polyurethane formed by a method described above.

In still a further aspect, the present invention provides a bone scaffold including a biodegradable polyurethane as described above. In that regard, the biodegradable polyurethanes of the present invention can, for example, have application in the fabrication of load-bearing allograft bone/polyurethane composites for use as resorbable fracture fixation devices.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1 sets forth chemical formulas for lysine diisocyanate methyl ester, lysine tryiisocyanate and poly(ε-caprolactone-co-glycolide-co-DL-lactide) triol and an embodiment of a synthetic scheme of the present invention.

FIG. 2 illustrates IR spectra for the polymer prepared from lysine diisocyanate and poly(ε-caprolactone-co-glycolide-co-DL-lactide) triol after incubating for 2 months in PBS.

FIG. 3 illustrates compressive stress-compressive strain curves for cast poly(ester urethane)s of the present invention.

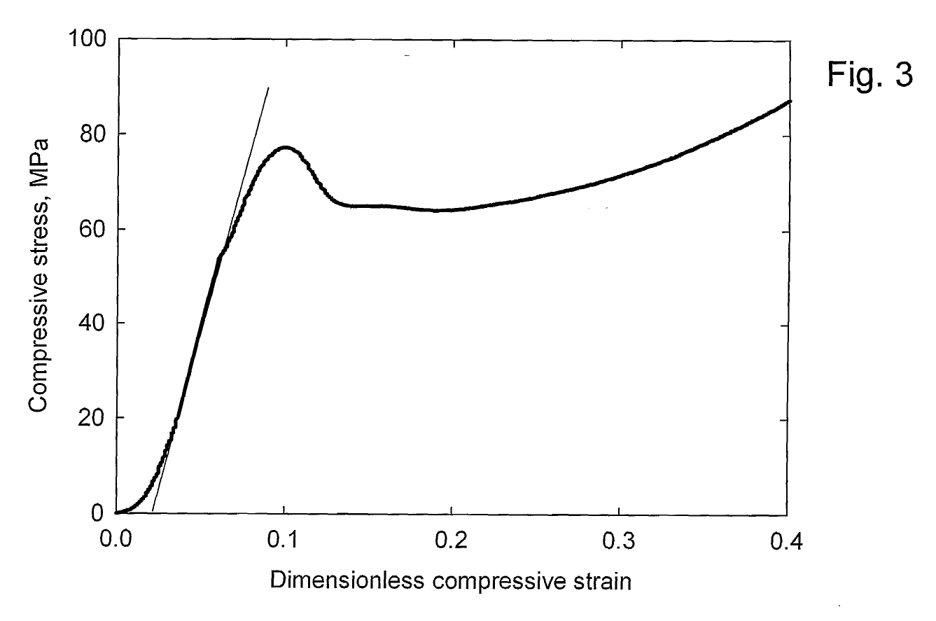

FIG. 4 illustrates mass loss as a result of degradation of cast poly(ester urethane)s of the present invention versus time.

FIG. 5 illustrates cytotoxicity of degradation products of cast poly(ester urethane)s of the present invention measured by LDH assay.

FIG. 6 illustrates live/dead staining of MC3T3 cells after 48 hrs of incubation on tissue culture polystyrene with polymer degradation products sampled at 4 months.

FIG. 7 illustrates scanning electron microscopy SEM micrographs of the polymer surface seeded with MC3T3 osteoblast cells after 24 hours.

FIG. 8 illustrates proliferation of MC3T3 cells on cast PEUR of the present invention wherein black bars represent day 1, light gray bars represent day 4, dark gray bars represent day 7, PLGA represents poly(DL-lactide-co-glycolide) and TCPS represents tissue culture polystyrene.

### DETAILED DESCRIPTION OF THE INVENTION

As used herein and in the appended claims, the singular forms “a,” “an”, and “the” include plural references unless the content clearly dictates otherwise. All publications, patent applications, patents, and other references mentioned herein are incorporated by reference in their entirety.

As used herein, the term “biodegradable” refers generally to the ability to be broken down (especially into innocuous degradation products) over time in the environment of use. As used herein, the term “biocompatible” refers generally to compatibility with living tissue or a living system. In that regard, for example, the poly(ester urethane) (PEUR) and degradation products of the present invention are preferably substantially nontoxic and/or substantially non-injurious to the living tissue or living system in the amounts required over the period of contact/exposure. Moreover, such materials preferably do not cause a substantial immunological reaction or rejection in the amounts required over the period of contact/exposure. As used herein, the term “nontoxic” generally refers to substances which, upon ingestion, inhalation, or absorption through the skin by a human or animal, do not cause, either acutely or chronically, damage to living tissue, impairment of the central nervous system, severe illness or death.

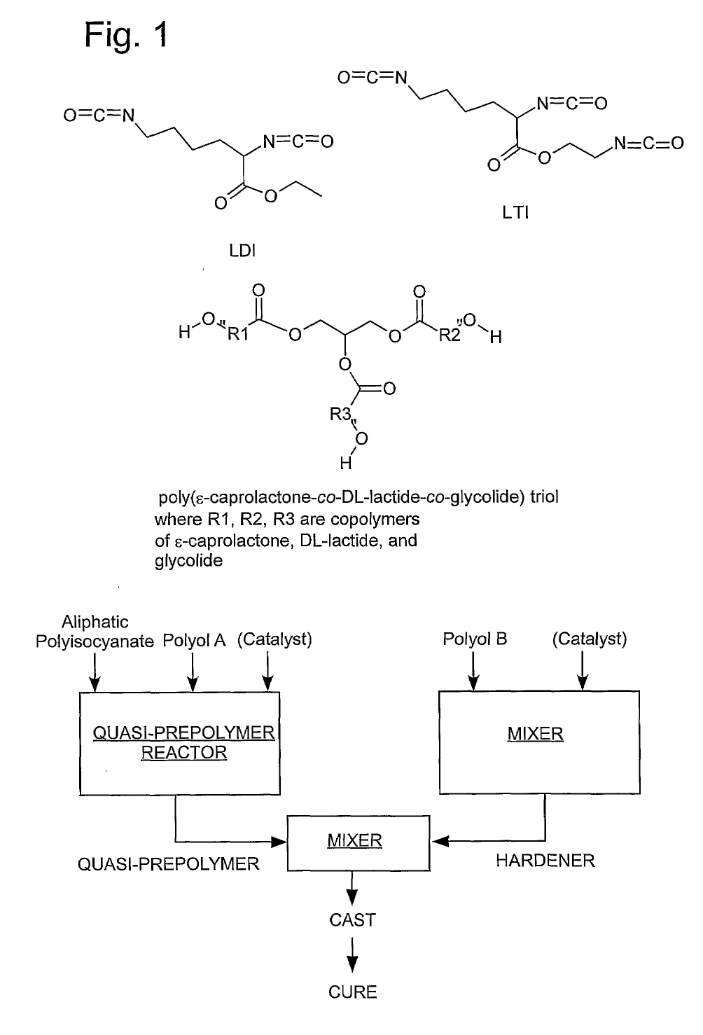

In the quasi-prepolymer process of the present invention (see, for example, FIG. 1), the quasi-prepolymer can be prepared by contacting a polyol component including at least one polyol compound with an excess (typically a large excess) of a polyisocyanate component. The resulting quasi-prepolymer intermediate includes an adduct of polyisocyanate and polyol solubilized in an excess of polyisocyanate. The quasi-prepolymer can also be formed by using an approximately stoichiometric amount of polyisocyanate component in forming a prepolymer and subsequently adding additional polyisocyanate component. The quasi-prepolymer therefore exhibits both low viscosity, which facilitates processing, and improved miscibility as a result of the polyisocyanate-polyol adduct. Poly(ester urethane) (PEUR) networks can, for example, then be prepared by reactive liquid molding, wherein the quasi-prepolymer is contacted with a polyester polyol to form a reactive liquid mixture which is then cast into a mold and cured.

Suitable polyisocyanate compounds or multi-isocyanate compounds for use in the present invention include aliphatic polyisocyanate compounds. Suitable aliphatic polyisocyanate compounds include, but are not limited to, lysine diisocyanate, an alkyl ester of lysine diisocyanate (for example, the methyl ester or the ethyl ester), lysine triisocyanate, hexamethylene diisocyanate, isophorone diisocyanate (IPDI), 4,4′-dicyclohexylmethane diisocyanate (H₁₂MDI), cyclohexyl diisocyanate, 2,2,4-(2,2,4)-trimethylhexamethylene diisocyanate (TMDI), dimers prepared form aliphatic polyisocyanates, trimers prepared from aliphatic polyisocyanates and/or mixtures thereof. In general, the polyisocyanate used in the present invention preferably includes approximately 10 to 55% NCO by weight (wt % NCO=100*(42/Mw)). More preferably, the polyisocyanates include approximately 15 to 50% NCO.

Suitable polyol compounds for use in the polyol component (polyol A in FIG. 1) in preparation of the quasi-prepolymers of the present invention include, but are not limited to, starter compounds having a hydroxy functionality of at least 3 and/or polyester polyols. Preferably, such starter compounds have a molecular weight of no more than 300 g/mol. Starter compounds suitable for use in the present invention include, but are not limited to, at least one of glycerol, pentaerythritol, dipentaerythritol, tripentaerythritol, 1,2,4-butanetriol, trimethylolpropane, 1,2,3-trihydroxyhexane, myo-inositol, ascorbic acid, a saccharide, or sugar alcohols (for example, mannitol, xylitol, sorbitol etc.). The quasi-prepolymer can also include other compounds having multiple reactive hydrogen functional groups (for example, hydroxy groups, primary amine groups and/or secondary amine groups) to react with the isocyanate functionality of the polyisocyanate compound(s). Hydroxy functional compounds are preferred.

Suitable polyester polyols (polyol B in FIG. 1) for use in the present invention (in the polyol component used in synthesizing the quasi-prepolymer and/or in the polyester polyol added to the quasi-prepolymer in preparation of a reactive liquid mixture) include polyester polyols having an average hydroxy functionality greater than 2 and including hydrolysable polyester linkages. The polyester polyol can, for example, include polyalkylene glycol esters or polyesters prepared from cyclic esters. The polyester polyol can, for example, include poly(ethylene adipate), poly(ethylene glutarate), poly(ethylene azelate), poly(trimethylene glutarate), poly(pentamethylene glutarate), poly(diethylene glutarate), poly(diethylene adipate), poly(triethylene adipate), poly(1,2-propylene adipate), mixtures thereof, and/or copolymers thereof. The polyester polyol can also include, polyesters prepared from ε-caprolactone, glycolide, DL-lactide, mixtures thereof, and/or copolymers thereof. The polyester polyol can also, for example, include polyesters prepared from castor-oil.

In general, it is preferred that polyols and other compounds used in forming the quasi-prepolymer be miscible with the polyester polyol(s) used in forming the reactive liquid mixtures of the present invention. Moreover, it is desirable that the quasi-prepolymer be a flowable liquid at processing conditions. In general, the processing temperature is preferably no greater than 60° C. More preferably, the processing temperature is ambient temperature (25° C.)). Thus, polyols can be chosen to have a glass transition (Tg) temperature less than 60° C., less than 37° C. or even less than 25° C. Because the quasi-prepolymer is solubilized with excess polyisocyanate, however, compounds having glass transition temperatures higher than the processing temperature can be used. The molecular weight of the polyol(s) used in forming the quasi-prepolymer are preferably in the range of approximately 50 to 10,000 Da, more preferably in the range of approximately 50 to 3000 Da and, even more preferably, in the range of approximately 50 to 2000 Da. In general, the viscosity of the quasi-prepolymer is preferably matched to the viscosity of the polyester polyol (hardener) used to form the reactive liquid mixture. The viscosity of the quasi-prepolymers of the present invention is less than 80,000 cSt. In general, the viscosity of the quasi-prepolymer is preferably less than 10,000 cSt, more preferably less than 5000 cSt and, even more preferably, less than 3000 cSt.

The glass transition temperature of the polyester polyol used in forming the reactive liquid is preferably less than 60° C., less than 37° C. (approximately human body temperature) or even less than 25° C. In addition to affecting flowability at processing conditions, Tg can also affect degradation. In general, a Tg of greater than approximately 37° C. will result in slower degradation within the body, while a Tg below approximately 37° C. will result in faster degradation.

The molecular weight of the polyester polyol hardener used in forming the reactive liquid can, for example, be used to control the mechanical properties of the PEUR networks of the present invention. In that regard, using polyester polyols of higher molecular weight results in greater compliance or elasticity. The polyester polyol(s) used in forming the reactive liquids of the present preferably have a molecular weight less than approximately 20,000 Da. More preferably, the molecular weight is approximately in the range of 100 to 5000 Da. Even more preferably, the molecular weight is in the range of approximately 100 to 3000 Da.

A crosslinker can, for example, be added to the polyester polyol before contacting the quasi-prepolymer with the polyester polyol. Preferably, the crosslinker has a functionality of at least 3 and a molecular weight of no more than 300 g/mol. The crosslinker can, for example, include at least one of glycerol, pentaerythritol, dipentaerythritol, tripentaerythritol, 1,2,4-butanetriol, trimethylolpropane, 1,2,3-trihydroxyhexane, myo-inositol, ascorbic acid, a saccharide, or a sugar alcohol (for example, (for example, mannitol, xylitol, sorbitol etc.). Use of glycerol as a crosslinker is described in several examples set forth in the Experimental Examples section below.

In several representative examples of the present invention, poly(ε-caprolactone) triol (referred to herein as PCL) triol, having a glass transition temperature or T_{g} of −63° C., or poly(ε-caprolactone-co-glycolide-co-DL-lactide) triol (referred to herein as P6C3G1L), having a molecular weight of 300 Da and a T_{g} of −36° C., were reacted with lysine methyl ester diisocyanate (LDI) and lysine triisocyanate (LTI) via a two-step quasi-prepolymer process to produce biodegradable and biocompatible poly(ester urethane) networks. Amorphous polyester triol compositions with T_{g} less than ambient temperature (approximately 25° C.) were chosen to facilitate processing by reactive liquid molding. The composition of the polyester triols was varied as set forth in Table 1 to form four different prepolymers (designated QTPCL, QTP6C3G1L, QDPC and QDP6C3G1L as set forth in Table 1) to, for example, investigate the effects on PEUR degradation in vitro. Coscat 83 was used as a catalyst in the preparation of each quasi-prepolymer. In general, any conventional urethane catalyst can be used in the present invention. Preferred catalysts include catalysts exhibiting relatively low toxicity such as organobismuth compounds and tertiary amines. Organobismuth compounds are particularly preferred.

TABLE 1

| Prepolymer | QTPCL | QTP6C3G1L | QDPCL | QDP6C3G1L |
|---|---|---|---|---|
| Polyol | PCL | P6C3G1L | PCL | P6C3G1L |
| Polyisocyanate | LTI | LTI | LDI | LDI |
| Coscat 83 (ppm) | 466 | 466 | 400 | 908 |
| NCO:OH eq ratio | 7.10 | 7.10 | 4.04 | 4.04 |
| Polyisocyanate:polyol | 7.10 | 7.10 | 6.07 | 6.07 |
| molar ratio | | | | |
| % free NCO | 34.5% | 34.5% | 23.9% | 23.9% |

PEUR networks were synthesized from both LDI and LTI (see FIG. 1) to, for example, investigate the effects of polyisocyanate functionality on the mechanical and biological properties. Experimental conditions for the synthesis of several representative cast PEURs of the present invention are summarized in Table 2.

TABLE 2

| Polymer | PTPCL | PTP6C3G1L | PDPCL | PD6C3G1L |
|---|---|---|---|---|
| Polyol | PCL | P6C3G1L | PCL | P6C3G1L |
| Prepolymer | QTPCL | QTP6C3G1L | QDPCL | QD6C3G1L |
| M_{c}, g mol⁻¹ | 208 | 208 | 432 | 432 |
| Index | 115 | 115 | 115 | 115 |

A number of physical and mechanical properties of the resulting PEUR networks of the present invention are set for in Table 3. For example, contact angle data are listed for each of the four materials in Table 3 and were found to vary from 64-76°. Polymers prepared from P6C3G1L exhibited higher contact angles compared to those prepared from PCL, which is surprising considering that P6C3G1L is more hydrophilic than PCL. In that regard, the solubility parameter of P6C3G1L is 10.58, as compared to 9.78 for PCL.

TABLE 3

| | PTPCL | PTP6C3G1L | PDPCL | PD6C3G1L |
|---|---|---|---|---|
| Contact angle (degrees) | 65.2 ± 2.9 | 75.8 ± 1.9 | 64.2 ± 3.9 | 69.5 ± 1.9 |
| Molecular weight | 208 | 208 | 430 | 430 |
| between crosslinks, | | | | |
| (g mol⁻¹) | | | | |
| Density (kg m⁻³) | 1213 ± 6 | 1274 ± 5 | 1189 ± 4 | 1226 ± 5 |
| Modulus (MPa) | 1321 ± 32 | 1427 ± 39 | 1203 ± 29 | 1381 ± 30 |
| Yield strength (MPa) | 94.4 ± 1.7 | 110.9 ± 1.4 | 82.1 ± 3.2 | 96.2 ± 5.6 |
| Yield strain (%) | 11.4 ± 0.5 | 11.0 ± 0.5 | 10.1 ± 0.4 | 10.9 ± 0.5 |

The average molecular weight between crosslinks M̅_{c} was calculated as:

M̅_{c,D}=2 M̅_{P,B}+M_{LDI} (1)

M̅_{c,T}= M̅_{P,B}+ M̅_{T,B} (2)

where M̅_{c,D} ( M̅_{c,T}) is the average molecular weight between crosslinks for lysine diisocyanate (lysine triisocyanate) and M_{LDI} is the molecular weight of LDI. The average molecular weight of a branch (B) of the polyester triol is given by:

$${\overline{M}}_{P , B} = \frac{1}{3} ( {\overline{M}}_{P} + 2 {M}_{CH} ) \qquad ( 3 )$$

where M̅_{P} is the number-average molecular weight of the polyester triol (for example, 300 Da) and M_{CH}=13 g mol⁻¹ is the molecular weight of the

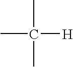

crosslink site in the polyester triol. The average molecular weight of a branch (B) of LTI is given by:

$${\overline{M}}_{T , B} = \frac{1}{3} ( {M}_{LTI} + 2 {M}_{CH} ) \qquad ( 4 )$$

The average molecular weight between crosslinks for the LTI materials was 208 g mol⁻¹, while that for the LDI materials was 430 g mol⁻¹.

The densities of each of the four materials are listed in Table 3 and range from 1189-1276 kg m⁻³. The PTP6C3G1L (LTI/P6C3G1L) material had the highest density, while the PDPCL (LDI/PCL) material had the lowest density. The higher density of the LTI materials (for a given polyester triol) is believed to result from the higher crosslink density (e.g., lower molecular weight between crosslinks), which reduces the conformational entropy of the system. See Sperling, L. H., Introduction to Physical Polymer Science. 3rd ed.; Wiley-Interscience: New York, 2001. The data in Table 3 also indicate that for a given polyisocyanate, the P6C3G1L materials have a higher density than the PCL materials.

The values of Young's modulus and the compressive yield strength and strain for each of the four materials are listed in Table 3. The value of Young's modulus were measured under a compression deformation mode ranges from 1.2-1.4 GPa for the four materials. The values of Young's modulus varied from 1203-1427 MPa and the compressive yield strength varied from 82-111 MPa. For a given polyester triol, the materials synthesized from LTI were found to have compressive strengths about 15% higher and Young's moduli about 3-10% higher than the corresponding values for materials synthesized from LDI.

The PDPCL material had a Young's modulus of 1203±29 MPa and a compressive strength of 82.1±3.2 MPa, whereas the material prepared from LDI and PCL (300 Da) via the prepolymer process of Published PCT International Patent Application No. WO/2004/009227 had a substantially lower Young's modulus of 837 MPa and a substantially lower compressive strength of 61.9 MPa. The NCO-terminated prepolymer used to synthesize the cast PEUR of Published PCT International Patent Application No. WO/2004/009227 had a viscosity of 87,000 cSt, which is considerably higher than that of the PCL triol (<1000 cSt). Without limitation to any particular mechanism, the higher modulus and compressive strength of the material prepared via the quasi-prepolymer process of the present invention are believed to result from the similar viscosities of the quasi-prepolymer and PCL triol, which can facilitate improved mixing and minimize phase-separation during cure. In general, the viscosities of the quasi-prepolymers of the present invention were close to the viscosities of the polyester polyol hardeners (which were in the range of approximately 600 to 1000 cSt)

PEURs synthesized from LDI and PCL triol (419 Da) in prior studies via a one-shot process had elastomeric properties, with a tensile modulus of 5.6 GPa, tensile strength of 3.8 MPa, and elongation at break of 81%. See Bruin, P.; Veenstra, G. J.; Nijenhuis, A. J.; Pennings, A. J., Design and synthesis of biodegradable poly(ester-urethane) elastomer networks composed of non-toxic building blocks. Makromol Chem, Rapid Commun 1988, 9, 589-594. Segmented poly(ester urethane)ureas synthesized from 530-Da PCL diols in prior studies did not exhibit microphase-separation and a crystalline PCL phase. See Gisselfaelt, K.; Edberg, B.; Flodin, P., Synthesis and properties of degradable poly(urethane urea)s to be used for ligament reconstructions. Biomacromolecules 2002, 3, 951-958. This observation indicates that the 419-Da PCL triol is amorphous. It is interesting that a 40% increase in polyester molecular weight yields a material with elastomeric mechanical properties rather than those of a rigid plastic.

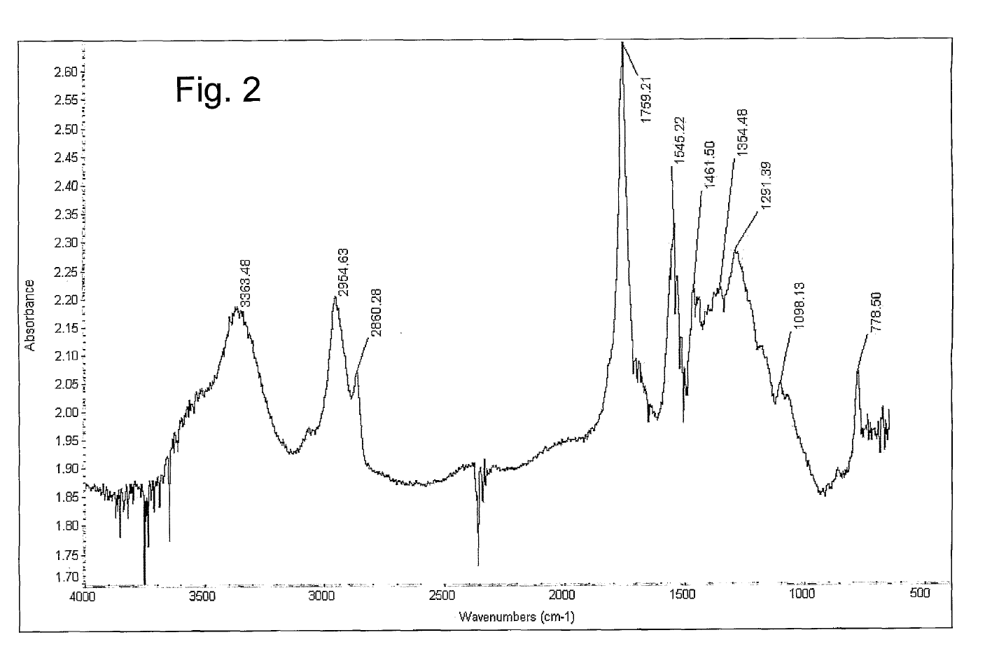

FIG. 2 illustrates IR spectra for the polymer PD6C3G1L, prepared from lysine diisocyanate and poly(ε-caprolactone-co-glycolide-co-DL-lactide) triol, after incubating for 2 months in PBS The absence of an NCO peak at 2285-2250 cm⁻¹ indicates that there is a negligible amount of free NCO. See Kothandaraman, H.; Nasar, A. S.; Lakshmi, R. K., Synthesis and thermal dissociation of pheno- and naphthol-blocked diisocyanates. J Appl Polymer Sci 1994, 53, 31-38, Socrates, G., Infrared Characteristic Group Frequencies: Tables and Charts. 2nd ed.; John Wiley & Sons: New York, 1994 and Kuptsov, A. H.; Zhizhin, G. N., Handbook of Fourier Transform Raman and Infrared Spectra of Polymers. Elsevier: Amsterdam, 1998, the disclosures of which are incorporated herein by reference. The intensity of the peak at 2353 cm⁻¹ varies for each sample and is assigned to the C═O stretching vibration of carbon dioxide. See Pecsok, R. L.; Shields, L. D., Modern Methods of Chemical Analysis. Wiley: New York, 1968, the disclosure of which is incorporated herein by reference. Variation between materials is believed to result from differences associated with the background spectrum, which is subtracted from the experimental spectrum. The peak at 1765 cm⁻¹ corresponds to ester and urethane C═O stretching vibrations and is consistent with that previously reported (1723 cm⁻¹)¹¹ for the adduct of glucose and LDI. See Zhang, J.-Y.; Beckman, E. J.; Piesco, N. J.; Agarwal, S., A new peptide-based urethane polymer: synthesis, biodegradation, and potential to support cell growth in vitro. Biomaterials 2000, 21, 1247-1258. Other peaks associated with urethane and ester groups are listed in Table 4. The IR data confirm the structure of the poly(ester urethane)urea and also indicate that the materials have completely cured after 24 h at room temperature.

TABLE 4

| Wavenumber | |
|---|---|
| cm⁻¹ | Assignment |
| 3364 | Secondary urethane N—H stretching vibration (non- |
| | hydrogen bonded) |
| 2955 | Asymmetric methylene C—H stretching vibration |
| 2860 | Symmetric methylene C—H stretching vibration |
| 1759 | Alkyl ester C═O stretching vibration, alkyl urethane |
| | C═O stretching vibration: amide I band |
| 1545 | Amide II band: motion combining N—H bending, C—N |
| | stretching vibrations of —CO—NH— group in trans form |
| 1291 | Asymmetric ester C—O—C stretching vibration |
| 1098 | Symmetric ester C—O—C stretching vibration |

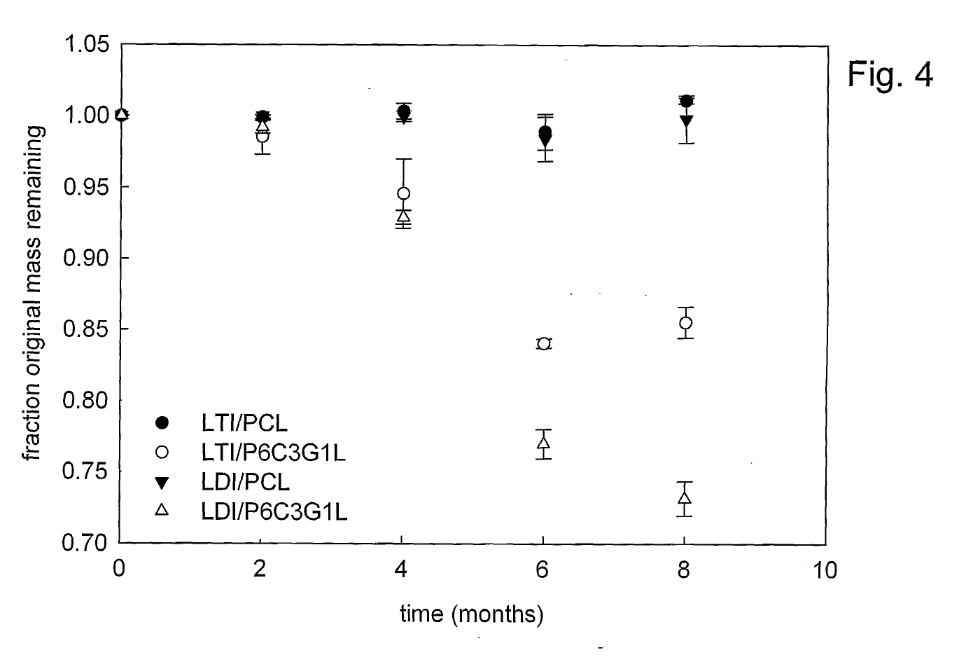

The mass of the PEUR networks is plotted versus time for PEUR networks incubated in PBS at 37° C. in FIG. 4. The composition of the polyester triol was found to have a significant effect on the in vitro biodegradation rate. In that regard, the materials prepared from PCL triol exhibited minimal (e.g., <5%) degradation after 8 months. However, materials prepared from P6C3G1L triol exhibited 15-27% mass loss after 8 months. These observations are consistent with the faster degradation rate of P6C3G1L (e.g., half life=28 days) compared to that of PCL. See Sawhney, A. S.; Hubbell, J. A., Rapidly degraded terpolymers of D,L-lactide, glycolide, and ε-caprolactone with increased hydrophilicity by copolymerization with polyethers. J Biomed Mater Res 1990, 24, 1397-1411, the disclosure of which is incorporated herein by reference. These data indicate that differences in the half-life of the polyester translate to differences in the degradation rate of the PEUR network and further indicate that it is possible to tune the degradation rate of the PEUR network by varying the polyester triol composition. Polyisocyanate composition also has an effect on PEUR biodegradation rate. Without limitation to any mechanism, it is believed that the faster biodegradation rate of PD6C3G1L relative to that of PTP6C3G1L is attributed to two factors: (a) hydrolysis of the methyl ester in LDI yields an acid which could catalyze the hydrolysis of other ester bonds in the backbone, and (b) the lower crosslink density of LDI-based materials promotes faster degradation.

Hydrolysis of PEUR networks in sodium hydroxide solutions has been reported to yield L-lysine as a degradation product; however, the presence of L-lysine in the degradation products under physiological conditions was not confirmed. See Storey, R. F.; Wiggins, J. S.; Mauritz, K. A.; Puckett, A. D., Bioadsorbable composites II: Nontoxic, L-lysine-based poly(ester-urethane) matrix composites. Polymer Composites 1993, 14, 17-25. Other studies reported the presence of lysine in the degradation products from lysine-derived PEUR networks. See Zhang, J.-Y.; Beckman, E. J.; Hu, J.; Yuang, G.-G.; Agarwal, S.; Hollinger, J. O., Synthesis, biodegradability, and biocompatibility of lysine diisocyanate-glucose polymers. Tissue Eng 2002, 8, (5), 771-785 and Zhang, J.-Y.; Beckman, E. J.; Piesco, N. J.; Agarwal, S., A new peptide-based urethane polymer: synthesis, biodegradation, and potential to support cell growth in vitro. Biomaterials 2000, 21, 1247-1258. IR data from the current study suggest that soluble urethane fragments are present in the degradation products, indicating incomplete hydrolysis. The presence of lysine could not be confirmed by IR analysis, however.

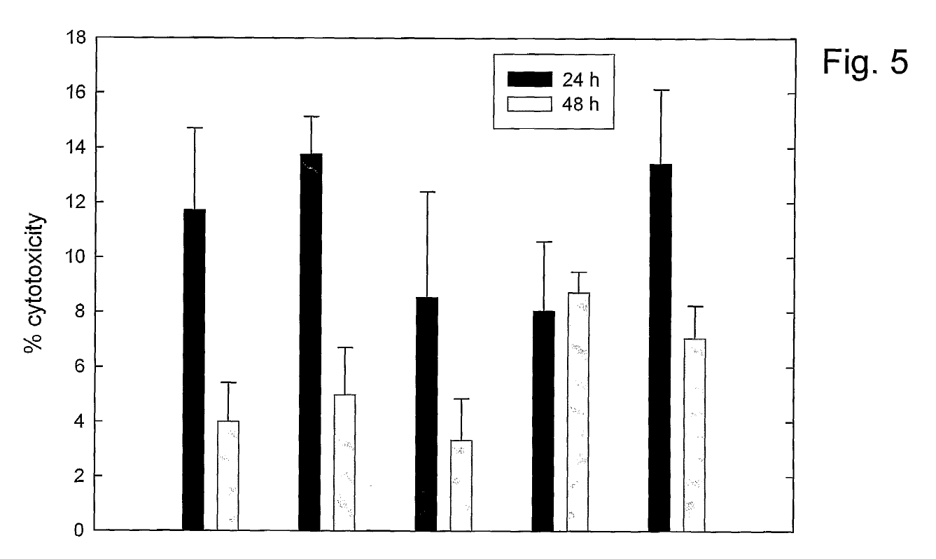

The cytotoxicity of the degradation products collected after 8 months of incubation in PBS, as measured by LDH assay, is shown at 24 and 48 h in FIG. 5, respectively. The data indicate that the cytotoxicity is <25% and comparable in most cases to the control (PBS). These data indicate that the degradation products from the PEUR networks have low cytotoxicity.

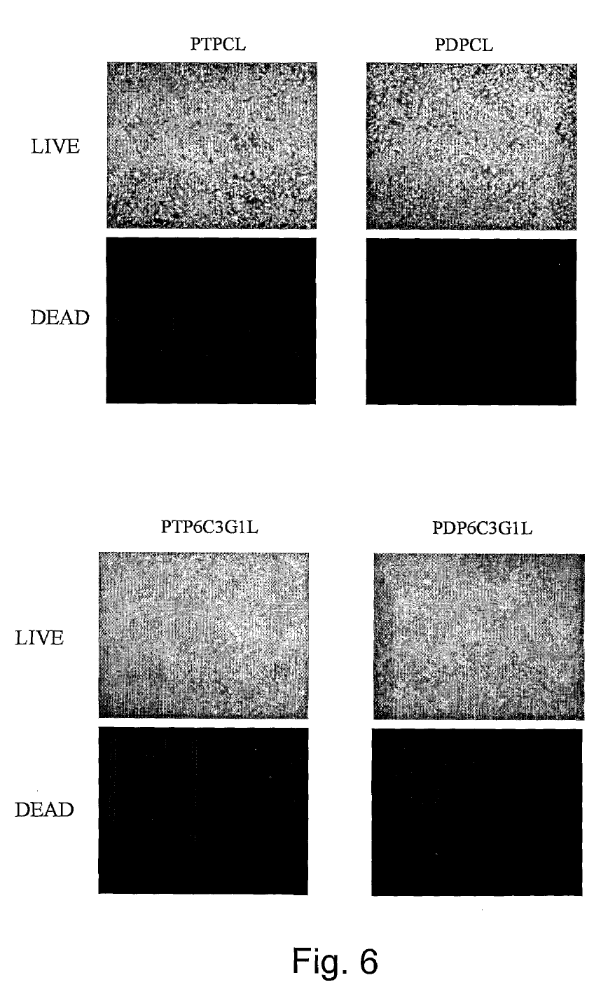

Live/dead images of MC3T3 cells incubated for 48 h on tissue culture polystyrene in degradation products from each of the four polymers sampled at 4 months are shown in FIG. 6. The images indicate a high number of viable cells, which is consistent with the LDH assay results and support the observation that the degradation products from the cast PEUR networks have low cytotoxicity.

The data in FIGS. 5 and 6 indicate that the degradation products from the PEUR networks have low cytotoxicity comparable to the control values in most cases. These data are consistent with those from previous studies indicating that PEUR networks prepared from LDI degrade to non-cytotoxic by-products both in vitro and in vivo. Furthermore, there appear to be no consistent differences in cytotoxicity of degradation products from PEUR networks synthesized from LDI and LTI.

MC3T3 osteoblast cell attachment on cast PEUR after 24 h was studied using SEM images in which actin was stained with phalloidin TRITC and nucleus was stained with Hoescht blue. SEM images of the polymer surface seeded with MC3T3 osteoblast cells after 24 hours illustrated that the cells were well-adhered to the polymer surface and were arranged in a pattern along the lines of the polymer grooves. A flat fibroblastic morphology showed that the cells were anchored well to the surface of the polymer

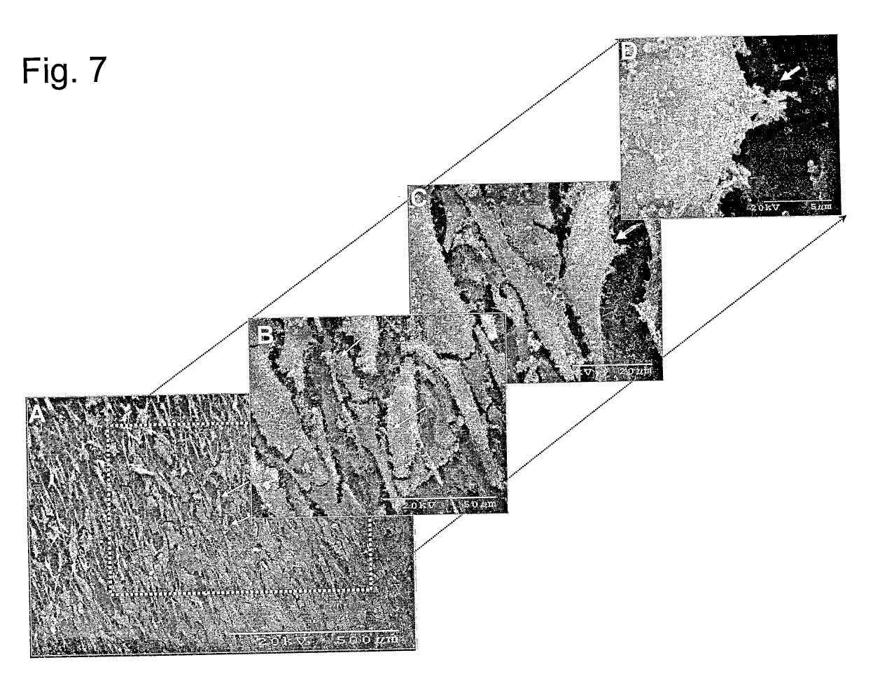

As set forth above, contact angles measured for PEUR networks vary from 64-76°, which are within the range of 45-76° reported to support attachment of mammalian cells. See Harbers, G. M.; Grainger, D. W., Cell-material interactions: fundamental design issues for tissue engineering and clinical considerations. In An Introduction to Biomaterials, Guelcher, S. A.; Hollinger, J. O., Eds. CRC Press: Boca Raton, Fla., 2006. Similar to the SEM images discussed above, FIG. 7 illustrates that MC3T3 cells attached to the surfaces of all four PEUR materials and exhibited a flat fibroblastic morphology, indicating that the cells are well-attached to the surface. These observations are consistent with those of previous studies reporting that PEUR networks synthesized from LDI support the migration of cells and growth of new tissue both in vitro and in vivo.

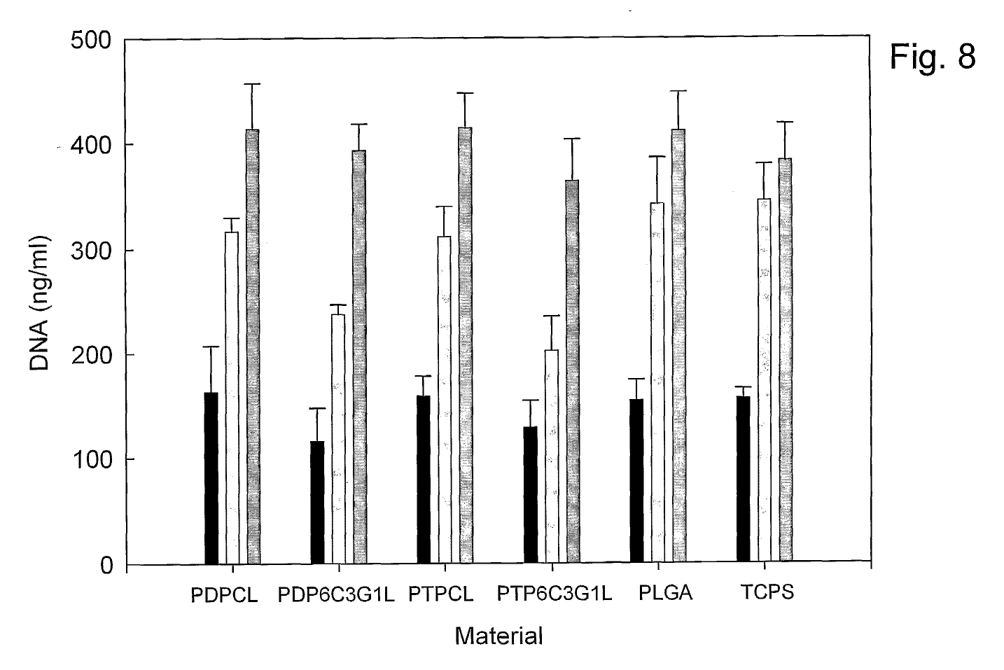

Counts of MC3T3 cells attached the surface of the PEUR materials on days 1, 4, and 7 are plotted in FIG. 8 and compared to PLGA and tissue culture polystyrene. The increase in cell counts from day 1 to days 4 and 7 indicate that the cells are proliferating on the surface of the PEUR materials.

Experimental

Synthesis of poly(ester urethane) networks. Methyl 2,6-diisocyanatohexane (lysine methyl ester diisocyanate, LDI) and lysine triisocyanate were purchased from Kyowa Hakko USA (New York). Coscat 83 catalyst was supplied by ChasChem, Inc. (Rutherford, N.J.). Stannous octoate, glycerol, poly(ε-caprolactone) triol (300 Da), and ε-caprolactone were purchased from Aldrich (St. Louis, Mo.). Glycolide and DL-lactide were purchased from Polysciences (Warrington, Pa.). Glycerol was dried at 10 mm Hg for 3 hours at 80° C. and ε-caprolactone was dried over anhydrous magnesium sulfate prior to use. All other materials were used as received. Two-component cast poly(ester urethane)s were mixed using a Hauschild SpeedMixer™ DAC 150 FVZ-K (FlackTek Inc., Landrum, S.C.).

Polyester triol synthesis. Two-component cast PEURs were synthesized from two polyester triols having a molecular weight of 300 Da. Poly(ε-caprolactone) triol (PCL, 300 Da) was purchased from Aldrich. A 300-Da triol was synthesized from a glycerol starter and a mixture of monomers comprising 60% caprolactone, 30% glycolide, and 10% DL-lactide (P6C3G1L) using previously published techniques. See, for example, Sawhney, A. S.; Hubbell, J. A., Rapidly degraded terpolymers of D,L-lactide, glycolide, and ε-caprolactone with increased hydrophilicity by copolymerization with polyethers. J Biomed Mater Res 1990, 24, 1397-1411 and Briefly, the appropriate amounts of dried glycerol, dried ε-caprolactone, glycolide, DL-lactide, and stannous octoate (0.1 wt-%) were mixed in a 100-ml flask and heated under an argon atmosphere with mechanical stirring to 135° C. After a reaction time of approximately 30 hours, the mixture was removed from the oil bath. Nuclear magnetic resonance spectroscopy (NMR) was performed with a Bruker 300 MHz NMR to verify the structure of the polyester triols using deuterated dichloromethane (DCM) as a solvent.

Quasi-prepolymer synthesis. Quasi-prepolymers were prepared by adapting published techniques previously used in connection with industrial, non-biodegradable polyurethanes. See, for example, Cardy, C. F. Process for preparing poly(ε-caprolactone) polyurethanes. U.S. Pat. No. 4,086,214, Apr. 25, 1978, 1978, Oertel, G., Polyurethane Handbook. 2nd ed.; Hanser Gardner Publications: Berlin, 1994, and Szycher, M., Szycher's Handbook of Polyurethanes. CRC Press: Boca Raton, 1999. The polyester triol was charged to a 100-ml three-neck flask fitted with a reflux condenser. The polyisocyanate (either LDI or LTI in the studies set forth herein) was then charged, the reactor immersed in an oil bath maintained at 90° C., and the mixture stirred under dry argon. After approximately 10 minutes, the Coscat 83 catalyst was charged to the reactor. The pressure in the reactor was then reduced to approximately 10 mm Hg by means of a vacuum pump. The reaction was allowed to proceed for three hours under vacuum at 90° C. After the reaction was complete, the reactor was purged with dry argon and the quasi-prepolymer poured from the reactor. To maintain stability, the quasi-prepolymer was stored under nitrogen at 4° C.

Synthesis of poly(ester urethane) networks. Two-component polyurethanes were cast from the quasi-prepolymers and polyester triols described previously. The quasi-prepolymer comprised the resin component while the hardener consisted of the polyester triol and Coscat 83 catalyst. The hardener was prepared by mixing the polyester polyol and catalyst in a 10-ml cup at 3300 rpm for 30 s in a Hauschild SpeedMixer™ mixer. The quasi-prepolymer was then added and mixed with the hardener at 3300 rpm for 15 s. The resulting reactive liquid mixture was cast into the appropriate mold and cured at 60° C. for 18 h. Specimens for compression testing were 8 mm diameter by 14 mm long cylinders. For cell culture experiments, the two-component PEURs were cast directly into the wells of a 12-well culture plate.

Synthesis of porous PEUR scaffolds. Porous cylinders (8 mm diameter by 6 mm thick) were prepared for in vitro degradation studies by a salt-casting technique. See, for example, Bruin, P.; Veenstra, G. J.; Nijenhuis, A. J.; Pennings, A. J., Design and synthesis of biodegradable poly(ester-urethane) elastomer networks composed of non-toxic building blocks. Makromol Chem, Rapid Commun 1988, 9, 589-594. The technique was similar to that used for the compression testing specimens except the appropriate amount of NaCl (sieved to 250 μm) was added to the hardener component prior to mixing. The amount of NaCl added was 80 wt-% of the total mass. The salt was then leached from the scaffold by mixing in deionized water for 48 h. Leaching was verified by SEM. At NaCl concentrations <˜78 wt-% the salt could not be leached from the scaffolds (implying lack of pore inter-connectivity), while at NaCl concentrations >˜82 wt-% the scaffold disintegrated during the leaching step.

Synthesis of PEUR with crosslinkers. The polymers were synthesized using the same synthetic techniques as described above. However, a glycerol crosslinker was added to the polyester polyol before addition of the polyester polyol to the quasi-prepolymer. Further, a zeolite moisture scavenger was used to remove water from the system. Conditions for preparation of the quasi-prepolymer using PCL triol (100 Mw), LDI and COSCAT 83 catalyst (organobismuth in carboxylic acid, available from Cosan Chemicals Co) are set forth in Table 5. Conditions for preparation of crosslinked PEURs from the quasi-prepolymer are set forth in Table 6. Mechanical properties of the resultant crosslinked PEURs are summarized in Table 7.

TABLE 5

| Component | ID | Mass | |
|---|---|---|---|
| Polyol: | PCL | 6.506 | g |
| Diisocyanate: | LDI | 36.551 | g |
| Catalyst: | COSCAT 83 | 0.045 | g |

TABLE 6

| | | | |
|---|---|---|---|
| | | 1JED96A | 1JED96B |
| Component | ID | Mass | Mass |

| | | | | | |
|---|---|---|---|---|---|
| Prepolymer: | 1JED96 | 6.952 | g | 7.434 | g |
| Crosslinker: | Glycerol | 0.514 | g | 0.797 | g |
| Polyester Polyol: | PCL300 | 2.459 | g | 1.730 | g |
| | Triol | | | | |
| | Zeolite | 0.533 | g | 0.536 | g |
| | Total Wt: | 10.458 | g | 10.497 | g |

TABLE 7

| | Sample #: | | | |
|---|---|---|---|---|
| | 1JED96A | | 1JED96B | |
| | mean | SD | mean | SD |
| Yield Strength (MPa) | 78.553 | 4.407 | 84.223 | 7.563 |
| Yield Strain | 0.283 | 0.079 | 0.305 | 0.037 |
| Maximum Strain | 0.696 | 0.022 | 0.690 | 0.052 |
| Modulus (MPa) | 620.040 | 163.079 | 563.703 | 66.674 |

Density. Polymers were cast as cylinders (8 mm in diameter and approximately 14 mm tall). Roughly 1 mm was cut off each end with a razor blade to ensure a flat surface. Height and diameter were measured with calipers and the samples were weighed to calculate the density.

Mechanical properties. Compression tests were designed to conform to ASTM standard D695-96. Briefly, samples were placed between platens on an Enduratec SmartTest Servo-Pneumatic Axial-Torsional system with an attached load cell to give continuous load data. The samples were compressed at a rate of 1.3 nm/min and load and position were measured every 0.25 seconds. By dividing the load by the cross-sectional area of the sample, the compressive stress was calculated in MPa. Young's modulus was calculated from the tangent to the initial linear portion of the load deformation curve after toe-in. See Sperling, L. H., Introduction to Physical Polymer Science. 3rd ed.; Wiley-Interscience: New York, 2001. Compressive yield strength was measured as the maximum load achieved after the initial linear period.

Attachment of MC3T3-E1 cells on PEUR networks. To evaluate attachment of osteoprogenitor cells to the surfaces of PEUR networks in vitro, MC3T3-E1 osteoblast-like cells were seeded on the cast polymer disc under static condition for 48 h and either fixed with 2.5% glutaraldehyde for SEM or 4% Paraformaldehyde for actin and Matrix Metalloproteinase-1 (MP-1) staining. Osteoblast cells were stained with Phalloidin TRITC to visualize actin organization and cell anchorage to the cast polymer surface and counter stained for nucleus with hoescht blue.

In vitro proliferation of MC3T3-E1 cells on PEUR networks. Counts of MC3T3 cells were determined by CyQuant assay on Days 1, 4, and 7.

In vitro biodegradation and cytotoxicity of degradation products. Porous cast PEUR discs were incubated in PBS at 37° C. in 5% CO₂ for 2, 4, 6, and 8 months. The discs were removed from the PBS at the appropriate time point and dried under vacuum (10 mm Hg) at 37° C. for 48 h. After drying, the polymer discs were weighed and the weight loss calculated. The biodegradation media were collected and tested for cytotoxicity (LDH assay) and live/dead staining after 24 and 48 hours of incubation. A portion of the biodegradation products were lyophilized and analyzed using micro PT-IR (Nicollet Continuμm™).

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

1. A method for preparing biodegradable polyurethanes comprising:
contacting a flowable quasi-prepolymer comprising free aliphatic polyisocyanate compounds with a polyester polyol hardener having a functionality of at least two to form a reactive liquid mixture.

2. The method of claim 1 wherein the quasi-prepolymer is formed by contacting a polyisocyanate component comprising at least one aliphatic polyisocyanate compound with a polyol component comprising at least one polyol compound to form an adduct of the polyisocyanate component and the polyol component wherein a sufficient excess of the polyisocyanate component is used to form the quasi-prepolymer.

3. The method of claim 2 wherein the polyisocyanate component is contacted with the polyol component in the presence of a catalyst.

4. The method of claim 3 wherein the catalyst is a tertiary amine or an organobismuth compound.

5. The method of claim 1 wherein the quasi-prepolymer is formed by contacting a polyisocyanate component comprising at least one aliphatic polyisocyanate compound with a polyol component comprising at least one polyol compound, wherein the molar ratio of aliphatic polyisocyanate compounds to polyol compounds is at least 2:1 and subsequently adding aliphatic polyisocyanate compound.

6. The method of claim 1 wherein the quasi-prepolymer is formed by contacting a polyisocyanate component comprising at least one aliphatic polyisocyanate compound with a polyol component comprising at least one polyol compound, wherein the molar ratio of aliphatic polyisocyanate compounds to polyol compounds is greater than 2:1.

7. The method of claim 1 wherein the quasi-prepolymer is formed by contacting a polyisocyanate component comprising at least one aliphatic polyisocyanate compound with a polyol component comprising at least one polyol compound, wherein the molar ratio of aliphatic polyisocyanate compounds to polyol compounds is greater than 3:1.

8. The method of claim 1 wherein the quasi-prepolymer is formed by contacting a polyisocyanate component comprising at least one aliphatic polyisocyanate compound with a polyol component comprising at least one polyol compound, wherein the molar ratio of aliphatic polyisocyanate compounds to polyol compounds is greater than 4:1.

9. The method of claim 6 wherein the polyisocyanate component is contacted with the polyol component in the presence of a catalyst.

10. The method of claim 9 wherein the catalyst is a tertiary amine or an organobismuth compound.

11. The method of claim 9 wherein the catalyst is an organobismuth compound.

12. The method of claim 1 wherein the polyester polyol has a functionality greater than 2.0.

13. The method of claim 1 wherein the polyester polyol has a functionality is at least 2.5.

14. The method of claim 12 wherein the polyester polyol comprises hydroxyl-terminated compounds having hydrolysable ester linkages:

15. The method of claim 14 wherein the polyester polyol comprises a polyalkylene glycol ester or a polyester prepared from at least one cyclic ester.

16. The method of claim 15 wherein the polyester polyol comprises poly(ethylene adipate), poly(ethylene glutarate), poly(ethylene azelate), poly(trimethylene glutarate), poly(pentamethylene glutarate), poly(diethylene glutarate), poly(diethylene adipate), poly(triethylene adipate), poly(1,2-propylene adipate), a mixture thereof, or a copolymer of at least two thereof.

17. The method of claim 15 wherein the polyester polyol comprises polyesters prepared from at least one of ε-caprolactone, glycolide or DL-lactide.

18. The method of claim 15 wherein the polyester polyol comprises polyesters prepared from castor-oil.

19. The method of claim 1 wherein the polyisocyanate compounds comprise at least one of lysine diisocyanate, an alkyl ester of lysine diisocyanate, lysine triisocyanate, hexamethylene diisocyanate, isophorone diisocyanate (IPDI), 4,4′-dicyclohexylmethane diisocyanate, cyclohexyl diisocyanate (H₁₂MDI), 2,2,4-(2,2,4)-trimethylhexamethylene diisocyanate (TMDI), dimers prepared form aliphatic polyisocyanates or trimers prepared from aliphatic polyisocyanates.

20. The method of claim 19 wherein the polyisocyanate compounds comprise at least one of hexamethylene diisocyanate dimer, hexamethylene diisocyanate trimer, isophorone diisocyanate dimer, or isophorone diisocyanate trimer.

21. The method of claim 19 wherein the alkyl ester of lysine diisocyanate is lysine diisocyanate methyl ester or lysine diisocyanate ethyl ester.

22. The method of claim 19 wherein the polyisocyanate compounds comprise lysine triisocyanate.

23. The method of claim 1 wherein the polyisocyanate component has an average isocyanate functionality of at least 2.

24. The method of claim 1 wherein the polyisocyanate component has an average isocyanate functionality of at least 2.5.

25. The method of claim 1 wherein a catalyst is added to the polyester polyol before contacting the quasi-prepolymer with the polyester polyol.

26. The method of claim 25 wherein the catalyst is a tertiary amine or an organobismuth compound.

27. The method of claim 1 wherein a crosslinker is added to the polyester polyol before contacting the quasi-prepolymer with the polyester polyol.

28. The method of claim 27 wherein the crosslinker has a functionality of at least 3 and a molecular weight of no more than 300 g/mol.

29. The method of claim 27 wherein the crosslinker comprises at least one of glycerol, pentaerythritol, dipentaerythritol, tripentaerythritol, 1,2,4-butanetriol, trimethylolpropane, 1,2,3-trihydroxyhexane, myo-inositol, ascorbic acid, a saccharide, or a sugar alcohol.

30. The method of claim 1 further comprising the step of casting the reactive liquid mixture into a mold.

31. The method of claim 30 further comprising the step of curing the biodegradable polyurethane in the mold.

32. The method of claim 1 wherein the flowable quasi-prepolymer comprises free aliphatic polyisocyanate compounds of at least 1% by weight.

33. The method of claim 1 wherein the flowable quasi-prepolymer comprises free aliphatic polyisocyanate compounds of at least 10% by weight.

34. The method of claim 1 wherein the flowable quasi-prepolymer comprises free aliphatic polyisocyanate compounds of at least 20% by weight.

35. The method of claim 2 wherein the polyol component comprises a polyester polyol.

36. The method of claim 35 wherein the polyester polyol has a functionality greater than 2.0.

37. The method of claim 35 wherein the polyester polyol has a functionality greater at least 2.5.

38. The method of claim 36 wherein the polyester polyol comprises hydroxyl-terminated compounds having hydrolysable ester linkages:

39. The method of claim 38 wherein the polyester polyol comprises a polyalkylene glycol ester or a polyester prepared from at least one cyclic ester.

40. The method of claim 39 wherein the polyester polyol comprises poly(ethylene adipate), poly(ethylene glutarate), poly(ethylene azelate), poly(trimethylene glutarate), poly(pentamethylene glutarate), poly(diethylene glutarate), poly(diethylene adipate), poly(triethylene adipate), poly(1,2-propylene adipate), a mixture thereof or a copolymer of at least two thereof.

41. The method of claim 39 wherein the polyester polyol comprises polyesters prepared from castor-oil.

42. The method of claim 2 wherein the polyol component comprises at least one of glycerol, pentaerythritol, dipentaerythritol, tripentaerythritol, 1,2,4-butanetriol, trimethylolpropane, 1,2,3-trihydroxyhexane, myo-inositol, ascorbic acid, a saccharide, or a sugar alcohol.

43. A quasi-prepolymer formed by contacting a polyisocyanate component comprising at least one aliphatic polyisocyanate compound with a polyol component comprising at least one polyol compound wherein an excess of the polyisocyanate component is used to result in free isocyanate component.

44. A quasi-prepolymer formed by contacting a polyisocyanate component comprising at least one aliphatic polyisocyanate compound with a polyol component comprising at least one polyol compound and subsequently adding polyisocyanate compounds to result in free isocyanate component.

45. A biodegradable polyurethane formed by contacting a flowable quasi-prepolymer comprising free aliphatic polyisocyanate compounds with a polyester polyol hardener having a functionality of at least two to form a reactive liquid mixture.

46. The biodegradable polyurethanes of claim 45 having a modulus greater than 837 MPa.

47. The biodegradable polyurethanes of claim 45 having a compressive strength greater than 61.9 MPa.

48. (canceled)

49. (canceled)

50. The method of claim 39 wherein the polyester polyol comprises polyesters prepared from at least one of ε-caprolactone, glycolide or DL-lactide.
